(19) United States
(12) Patent Application Publication
(10) Pub. No.: US 2026/0162987 A1
(43) Pub. Date: Jun. 11, 2026

(54) STACKED CELL ARCHITECTURE FOR VEHICLE BATTERY CELLS

(71) Applicant: GM Global Technology Operations LLC, Detroit, MI (US)

(72) Inventors: Dewen Kong, Shanghai (CN); Haijing Liu, Shanghai (CN); Seung-Woo Chu, Sterling Heights, MI (US); Fan Xu, Oakland Township, MI (US); Venkataramani Anandan, Cumming, GA (US)

(21) Appl. No.: 19/033,817

(22) Filed: Jan. 22, 2025

(30) Foreign Application Priority Data
Dec. 9, 2024 (CN) 202411803179.4

(51) Int. Cl. H01M 4/58; H01M 4/02; H01M 4/131; H01M 4/133; H01M 4/136; H01M 4/505; H01M 4/525; H01M 4/587; H01M 4/62; H01M 4/66; H01M 50/103; H01M 50/105

(52) U.S. Cl. CPC H01M 4/5825; H01M 4/131; H01M 4/133; H01M 4/136; H01M 4/505; H01M 4/525; H01M 4/587; H01M 4/622; H01M 4/625; H01M 4/661; H01M 2004/021; H01M 2004/027; H01M 50/103; H01M 50/105

(57) ABSTRACT

A lithium manganese iron phosphate (LMFP)-based vehicle battery cell is provided. The vehicle battery cell includes a cathode current collector, a cathode disposed on a surface of the cathode current collector, an anode current collector, and an anode disposed on a surface of the anode current collector. The cathode has an active material including at least one of lithium manganese iron phosphate (LMFP) or lithium nickel cobalt manganese aluminum oxide (NCMA). The anode has an active material including graphite. The anode current collector and the anode are disposed proximate to the cathode current collector and the cathode, and the anode and the cathode are separated by a separator.

### INTRODUCTION

The present disclosure relates to a vehicle battery pack and battery cells, and more particularly, to a lithium ion battery cell design within the battery pack.

Electric and hybrid electric vehicle technology is enabled by the development and deployment of rechargeable, secondary batteries, which provide energy to the vehicle powertrain. Secondary batteries include lithium ion batteries, which generally include a cathode, anode, separator, and electrolyte. The cathode provides a source of lithium ions and determines capacity and average voltage of a battery. The anode stores and releases lithium ions received from the cathode when energy is needed. The separator prevents the cathode and anode from contacting and shorting out the battery, and the electrolyte provides a medium between the cathode and anode through which the lithium ions travel. Energy density, or areal capacity, of the secondary battery may be increased by adding more cathode and anode active material and increasing the density of the cathode and anode.

Cathode electrodes and anode electrodes are formed by coating current collectors with active cathode material and active anode material, respectively. The coatings often include active materials, a binder, additives, and/or a solvent. At least in the case of cathodes, the active materials disposed on the current collectors are responsible for the electrochemical reactions that store and release energy during battery operation.

One of the primary issues is the mechanical, thermal, and chemical stability of the cathode and/or anode active materials during repeated charge and discharge cycles. Degradation of the cathode can lead to reduced capacity, lower efficiency, and shorter battery life. Another issue is the need for higher energy density and faster charging capabilities. The cathode and anode must be optimized to ensure efficient electron transport and minimize energy losses.

Thus, while present lithium cathode and anode chemistries achieve their intended purpose, there is a need for new and improved chemistries that offer improved mechanical, thermal, and chemical stability.

### SUMMARY

According to several aspects of the present disclosure, a lithium manganese iron phosphate (LMFP)-based vehicle battery cell is provided. The vehicle battery cell includes a cathode current collector, a cathode disposed on a surface of the cathode current collector, an anode current collector, and an anode disposed on a surface of the anode current collector. The cathode has an active material including at least one of lithium manganese iron phosphate (LMFP) or lithium nickel cobalt manganese aluminum oxide (NCMA). The lithium manganese iron phosphate (LMFP) has the formula LiMnₓFe_{1-x-y}M_{y}PO₄, where M includes at least one of titanium (Ti), Magnesium (Mg), aluminum (Al), calcium (Ca), niobium (Nb), cobalt (Co), or yttrium (Y), and x=0.5-0.9 and y=0-0.3. The lithium nickel cobalt manganese aluminum oxide (NCMA) has a formula LiNiCoMnAlO₂. The anode has an active material including graphite. The anode current collector and the anode are disposed proximate to the cathode current collector and the cathode, and the anode and the cathode are separated by a separator.

In accordance with another aspect of the disclosure, vehicle battery cell has an energy density between 460-580 watt-hours per liter (Wh/L).

In accordance with another aspect of the disclosure, the vehicle battery cell is at least one of a prismatic cell or a pouch cell.

In accordance with another aspect of the disclosure, the cathode current collector is aluminum.

In accordance with another aspect of the disclosure, the active material of the cathode includes a blend of LMFP and NCMA, and the LMFP is greater than 50% of the blend.

In accordance with another aspect of the disclosure, the active material of the cathode has a formula of LiMn_{0.75}Fe_{0.25}PO₄.

In accordance with another aspect of the disclosure, a capacity loading of the cathode is about 3.3 milliampere-hours per square centimeter (mAh/cm²).

In accordance with another aspect of the disclosure, a porosity of the cathode is 35% plus or minus 8%.

In accordance with another aspect of the disclosure, the anode is formed of at least one of artificial graphite (AG) or natural graphite (NG).

In accordance with another aspect of the disclosure, the anode is formed of a blend of about 50% artificial graphite (AG) and about 50% natural graphite (NG).

In accordance with another aspect of the disclosure, the anode current collector is formed of copper.

In accordance with another aspect of the disclosure, the lithium manganese iron phosphate (LMFP)-based vehicle battery cell includes a binder.

In accordance with another aspect of the disclosure, the lithium manganese iron phosphate (LMFP)-based vehicle battery cell includes a carbon additive.

According to several aspects of the present disclosure, battery for an electric vehicle is provided. The battery includes a battery cell. The battery cell includes a cathode current collector, a plurality of cathodes including an active material disposed on a surface of the cathode current collector, an anode current collector, an anode having an active material including graphite disposed on a surface of the anode current collector, a separator positioned between the cathode and the anode, and an electrolyte configured for carrying ions between the cathode and the anode. The active material includes at least one of lithium manganese iron phosphate (LMFP) having a formula LiMnₓFe_{1-x-y}M_{y}PO₄, where M includes at least one of titanium (Ti), Magnesium (Mg), aluminum (Al), calcium (Ca), niobium (Nb), cobalt (Co), or yttrium (Y), where x=0.5-0.9, and where y=0-0.3, or lithium nickel cobalt manganese aluminum oxide (NCMA) having a formula LiNiCoMnAlO₂.

In accordance with another aspect of the disclosure, the battery cell has an energy density between 460-580 watt-hours per liter (Wh/L).

In accordance with another aspect of the disclosure, the active material of the cathode has a formula of LiMn_{0.75}Fe_{0.25}PO₄.

In accordance with another aspect of the disclosure, the active material of the cathode includes a blend of LMFP and NCMA, and wherein the LMFP is greater than 50% of the blend.

In accordance with another aspect of the disclosure, the anode is formed of at least one of artificial graphite (AG) or natural graphite (NG).

In accordance with another aspect of the disclosure, the anode is formed of a blend of about 50% artificial graphite (AG) and about 50% natural graphite (NG).

According to several aspects of the present disclosure, lithium manganese iron phosphate (LMFP)-based vehicle battery cell is provided. The vehicle battery cell includes a cathode current collector, a cathode disposed on a surface of the cathode current collector, an anode current collector, and an anode disposed on a surface of the anode current collector. The cathode has an active material including lithium manganese iron phosphate (LMFP) having a formula LiMnₓFe_{1-x-y}M_{y}PO₄, where M includes at least one of titanium (Ti), Magnesium (Mg), aluminum (Al), calcium (Ca), niobium (Nb), cobalt (Co), or yttrium (Y), where x=0.5-0.9, and where y=0-0.3. The active material may also include nickel, cobalt, manganese, and aluminum (NCMA) having a formula LiNiCoMnAlO₂. The active material may also include a carbon additive and/or a binder. The anode has an active material including graphite and at least one of a carbon additive or a binder. The anode current collector and the anode are disposed proximate to the cathode current collector and the cathode, and the anode and the cathode are separated by a separator.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings.

FIG. 1 is a perspective view illustrating an example of a vehicle having an electric motor powered by a battery pack having a lithium manganese iron phosphate-based chemistry, in accordance with the present disclosure.

FIG. 2 is a cross section schematic view of a battery cell in the battery pack in the vehicle shown in FIG. 1, where the battery cell includes a lithium manganese iron phosphate-based cathode, in accordance with the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. The following description is merely exemplary in nature and is not intended to limit the present disclosure, application, or uses.

A battery cell architecture, a lithium manganese iron phosphate (LMFP) cathode, and an anode is disclosed herein. The optimized architecture and LMFP cathode active materials disclosed herein deliver a high thermal stability and a low cost product. Compared to conventional LFP cathode materials, the optimized LMFP cathode active materials exhibit higher energy densities of 460-580 watt hours per liter (Wh/L) representing an improvement between 10-38%.

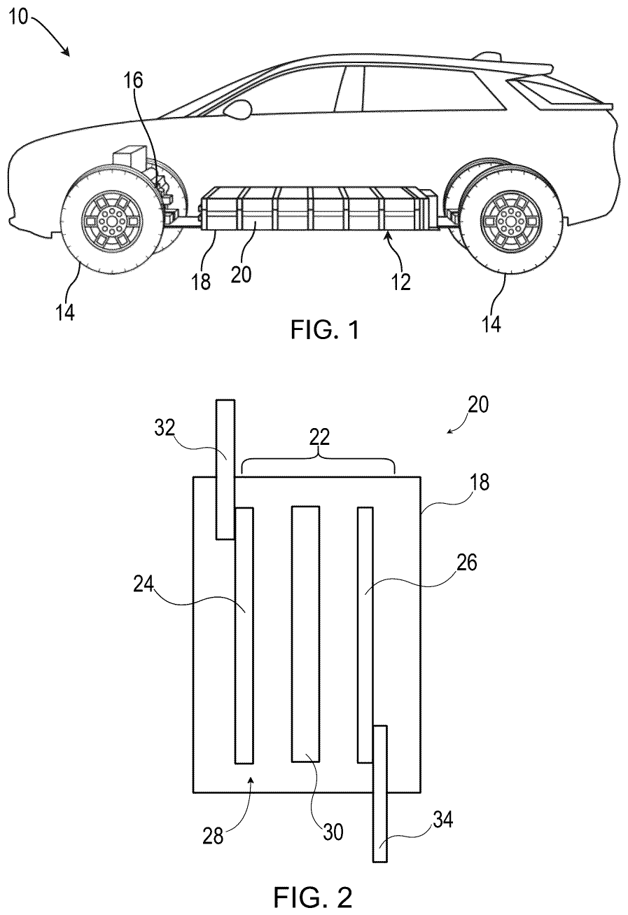

Referring to FIG. 1, a perspective view of a vehicle 10 having a battery pack μis illustrated, in accordance with the present disclosure. The battery pack 12 is illustrated with an exemplary vehicle 10. The vehicle 10 is an electric vehicle or hybrid vehicle having wheels 14 driven by at least one electric motor/inverter 16. The electric motors/inverters 16 receive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. Battery pack 12 includes a housing 18 for carrying and supporting a plurality of battery cells 20. In an example, the battery pack 12 may have fifty or more battery cells 20.

As used herein, the term “vehicle” is not limited to automobiles. While the present technology is described primarily herein in connection with electric and hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as in portable power stations, such as those used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

FIG. 2 illustrates one battery cell 20 within the battery pack 12 illustrated in FIG. 1. The battery pack 12 and the battery cells 20 are understood to be rechargeable batteries that may be discharged upon application of a load and recharged upon the application of an external power source. While the battery cells 20 are shown as prismatic-type battery cells, the battery cells 20 may also include, for example, pouch-style cells. Alternatively, the battery cells 20 may be cylindrical-style cells.

Each battery cell 20 disposed within the battery pack 12 shown in FIG. 1 has a housing 18 (or case or container) and at least one electrode stack 22, which further includes a cathode 24, an anode 26, an electrolyte 28, and/or a separator 30. Each battery cell 20 may have tens or hundreds of electrode stacks 22. Each electrode stack 22 is connected to a current collector 32, 34. The electrode stacks are placed in the housing 18, which are filled with an electrolyte 28. The electrolyte 28 transports ions between the cathode 24 and the anode 26. The current collectors 32, 34 are thin metal plates or foils disposed on sides of the electrode stacks 22 and/or housing 18 and typically have a thickness between 0.001 and 1 millimeter. The current collectors 32, 34 may be made of copper (e.g., 6 μm foil) or aluminum (e.g., 12 μm foil) and are attached to the electrode stacks 22 to transmit the electric current to an external circuit (not shown).

During discharge, when a load is applied to the battery cells 20, Li+ ions move from the anode 26 to the cathode 24 through the separator 30 by way of the electrolyte 28. Equivalent electrons e-move through battery circuitry from the cathode 24 to the anode 26, providing energy to a battery load. While charging and upon application of an external voltage, Li⁺ ions move from the cathode 24 to the anode 26 by way of the electrolyte 28 through the separator 30 and may be intercalated into the anode 26.

Each battery cell 20, such as that illustrated in FIG. 2, generally includes the cathode 24 disposed on a cathode current collector 32, the anode 26 disposed on an anode current collector 34, the separator 30 positioned between the cathode 24 and the anode 26, and the electrolyte 28. While the illustrated battery cells 20 show one anode 26 (and anode current collector 34) and one cathode 24 (and one cathode current collector 32), the battery cell 20 may alternatively include two or more cathodes 24 (and cathode current collectors 32) and one or more anodes 26 (and anode current collectors 34). In any of the designs above, one or more separators 30 are interleaved between the cathodes 24 and anodes 26 to prevent the cathodes 24 and the anodes 26 from contacting.

In the various styles of battery cells 20 noted above, the cathode current collector 32 and anode current collector 34 are formed from conductive materials. In embodiments, the cathode current collector 32 includes aluminum. Alternatively, or additionally, the cathode current collector 32 may include copper clad aluminum and/or stainless steel. The anode current collector 34 may include one or more of copper, nickel, stainless steel, or titanium. The current collectors 32, 34 are illustrated as being in the form of a foil; however, it should be appreciated that other forms may be exhibited such as mesh, wire, or a composite-type material. In embodiments, a foil cathode current collector 32 and a foil anode current collector 34 are impermeable to gas. The cathode current collector 32 may exhibit a thickness in the range of 5 micrometers to 50 micrometers including all values and ranges therein, for example in the range of 5 micrometers to 25 micrometers. The anode current collector 34 may exhibit a thickness in the range of 5 micrometers to 50 micrometers including all values and ranges therein, for example in the range of 5 micrometers to 25 micrometers.

The cathode 24 includes a cathode active material that provides a source of lithium ions (Li⁺) and can undergo reversible insertion or intercalation of lithium ions determining, for example, the capacity and average voltage of a battery. In embodiments, the active material includes lithium manganese iron phosphate (LMFP) and/or lithium nickel cobalt manganese aluminum oxide (NCMA). The cathode active material may include lithium manganese iron phosphate (LMFP) because LMFP batteries are known for their thermal stability and safety, because iron and manganese, which are more abundant and less expensive that other materials, such as nickel and cobalt, can lower the overall cost of batteries, and because LMFP batteries offer good energy density and long life cycle. The cathode active material may include lithium nickel cobalt manganese aluminum oxide (NCMA) because NCMA batteries have a high nickel content, which increases energy density, because NCMA reduces reliance on cobalt, which may be expensive, and because addition of aluminum enhances thermal stability and overall battery safety. The active cathode material may include different blend mass ratios of the LMFP and the NCMA. For example, a first cathode active material may include a design having 100% wt. of LMFP. In another example, a second cathode active material may include a design having a mass ratio of LMFP greater than 50% wt. with NCMA a balance (e.g., 70% wt. LMFP and 30% wt. NCMA, 80% wt. LMFP and 20% wt. NCMA, and so forth).

In embodiments, the cathode active material is present in the range of 82 percent by weight to 97.5 percent by weight of the total weight of the cathode 24, including all values and ranges therein, such as in the range of 91 percent by weight to 96 percent by weight of the total weight of the cathode 24. The total weight of the cathode is 100 weight percent. In embodiments, the cathode active material is provided as powder.

The lithium manganese iron phosphate (LMFP) exhibits the formula LiMnₓFe_{1-x-y}M_{y}PO₄, where M includes at least one of titanium (Ti), Magnesium (Mg), aluminum (Al), calcium (Ca), niobium (Nb), cobalt (Co), or yttrium (Y), and where x=0.5-0.9 and y=0-0.3. In a specific example, the lithium manganese iron phosphate (LMFP) has the formula LiMn_{0.75}Fe_{0.25}PO₄, where x=0.75. It will be appreciated that the LMFP may have other formulas that correspond with the previously disclosed ranges.

When LMFP is used, the cathode active material may also include coated carbon. For example, the coated carbon may be between about 1-5% wt., and preferably between about 1.5-2.5% wt. In this context, the term “about” will be understood by one of skill in the art. Alternatively, the term “about” is understood to mean plus or minus 0.1% wt. Additionally, the LMFP may have a specific surface area (BET (Brunaer-Emmett-Teller)) between about 5-30 square meters per gram (m²/g). In this context, the term “about” will be understood by one of skill in the art. Alternatively, the term “about” is understood to mean plus or minus 1 m²/g. The LMFP may have a tap density between about 0.5-2 grams per cubic centimeter (g/cm³), and preferably between about 0.6-1.2 g/cm³. In this context, the term “about” will be understood by one of skill in the art. Alternatively, the term “about” is understood to mean plus or minus 0.1 g/cm³. The LMFP may exhibit an average particle size in the range of 10 nanometers to 1000 nanometers, including all values and ranges therein, such as from 50 nanometers to 300 nanometers.

The lithium nickel cobalt manganese aluminum oxide (NCMA) exhibits the formula Li[NiₓCo_{y}Mn_{z}Al_{w}]O₂, where x, y, z, and w may vary. In one specific example, the NCMA formula may be Li[Ni_{0.8}Co_{0.1}Mn_{0.1}Al_{0.05}]O₂. In another example, x may be greater than 0.8 (e.g., x=0.87). It will be appreciated that the formula of NCMA may include other elemental proportions without departing from the scope of the present disclosure. Additionally, the NCMA may include a median particle size (D50) between about 2-15 micrometers (μm). In this context, the term “about” will be understood by one of skill in the art. Alternatively, the term “about” is understood to mean plus or minus 1 μm. The NCMA may have a specific surface area (BET (Brunaer-Emmett-Teller)) between about 0.3-3 square meters per gram (m²/g). In this context, the term “about” will be understood by one of skill in the art. Alternatively, the term “about” is understood to mean plus or minus 0.1 m²/g. The LMFP may have a tap density between about 0.5-2 grams per cubic centimeter (g/cm³), and preferably between about 0.6-1.2 g/cm³. In this context, the term “about” will be understood by one of skill in the art. Alternatively, the term “about” is understood to mean plus or minus 0.1 g/cm³. In embodiments, the LMFP may have a pH value between about 8-11 (e.g., in a 10% wt. dispersion). In this context, the term “about” will be understood by one of skill in the art. Alternatively, the term “about” is understood to mean plus or minus 0.1.

The active cathode material may further include carbon additives. For example, the carbon additives may include one or more of carbon black, graphite, graphene, graphene oxide, graphene nanoplates, Super P, acetylene black, carbon nanofibers, carbon nanotubes, single-walled carbon nanotubes (SWCNT), multi-walled carbon nanotubes (MWCNT) and other electronically conductive additives.

The active cathode material may further include carbon additives and/or a binder. A binder is used to hold the cathode material together in a compact and stable form within the battery cell. Some examples of a binder that may be included in the cathode 24 include poly(vinylidene fluoride) (PVDF), poly(vinylidene fluoride-co-hexafluoropropylene) (PVdF-HFP), polytetrafluoroethylene (PTFE), sodium carboxymethyl cellulose (CMC), styrene-butadiene rubber (SBR), styrene ethylene butylene styrene copolymer (SEBS), and the like.

The cathode 24 and the cathode active material may have a capacity loading of about 5 mAh/cm² (plus or minus 3 mAh/cm²) for a single sided coating of cathode active material on the cathode 24 (for a battery having a C-rate of 0.1 C at room temperature). Additionally, the cathode active material may have a pressing density of 2 g/cm³ (plus or minus 1 g/cm³) and a porosity of 35% (plus or minus 8%).

The cathode active material may include between about 90-97% wt. cathode active material, between about 1-5% wt. carbon additives, and between about 1-5% wt. binder formed using a N-Methyl-2-pyrrolidone (NMP) solvent for PVDF. In this context, the term “about” will be understood by one of skill in the art. Alternatively, the term “about” will be understood to mean plus or minus 0.2% wt.

In a specific example, the cathode 24 and cathode active material are formed with 96.3% wt. of LMFP/NCMA blend mass ratio of 100% wt. LMFP, where the LMFP has a formula LiMn_{0.75}Fe_{0.25}PO₄, 0.7% wt. Super P, 0.5% wt. MWCNT, and 2.5% wt. PVDF. In this example, the LMFP includes 2.2% wt. coated carbon with a median size (D50) of about 8 μm and a specific surface area (BET) of about 2.2 m²/g. In this example, the cathode has a capacity loading of about 3.3 mAh/cm², a pressing density of 2.4 g/cm³ and a porosity of 28%.

In a second specific example, the cathode 24 and cathode active material are formed with 96.3% wt. of LMFP/NCMA blend mass ratio of 70% wt. LMFP and 30% wt. NCMA (e.g., ratio is 7/3), where the LMFP has a formula LiMn_{0.75}Fe_{0.25}PO₄ and the NCMA includes nickel (Ni) at a ratio of 0.87, 0.7% wt. Super P, 0.5% wt. MWCNT, and 2.5% wt. PVDF. In this example, the cathode has a capacity loading of about 3.5 mAh/cm², a pressing density of 2.6 g/cm³ and a porosity of 28%.

In a third specific example, the cathode 24 and cathode active material are formed with 96.3% wt. of LMFP/NCMA blend mass ratio of 80% wt. LMFP and 20% wt. NCMA (e.g., ratio is 8/2), where the LMFP has a formula LiMn_{0.75}Fe_{0.25}PO₄ and the NCMA includes nickel (Ni) at a ratio of 0.87, 0.7% wt. Super P, 0.5% wt. MWCNT, and 2.5% wt. PVDF. In this example, the cathode has a capacity loading of about 3.45 mAh/cm², a pressing density of 2.5 g/cm³ and a porosity of 28%.

The anode 26 includes materials that can undergo reversible insertion or intercalation of lithium ions at a lower electrochemical potential than the cathode 24 material, such that an electrochemical potential difference exists between the anode 26 and cathode 24. The anode 26 may include one or more of lithium metal; alloys of lithium for example lithium silicon alloy, lithium aluminum alloy, lithium indium alloy, lithium titanate, and lithium tin alloy; carbon based materials for example graphite, activated carbon, carbon black and graphene; silicon; silicon based alloys; silicon oxide; silicon based composite materials; tin oxide; aluminum; indium; zinc; germanium; and titanium oxide; as well as any combination of the above. In embodiments, the anode 26 may exhibit a thickness in the range of 50 micrometers to 150 micrometers including all values and ranges therein. The anode 26 may be applied to the anode current collector 34 forming a coating on the anode current collector 34 by using a deposition process, for example a slurry based process, a hot roll pressing process, extrusion, or additive manufacturing. The combined anode 26 and anode current collector 34 provide an anode electrode.

The anode 26 includes an active anode material. The active anode material can include an artificial-type graphite (AG graphite) and/or a natural-type graphite (NG graphite), at least one binder, and/or at least one carbon additive. AG graphite, also known as synthetic graphite, includes a man-made form of carbon that is produced through high-temperature treatment of carbon materials like petroleum coke and coal tar pitch. NG graphite may include a naturally occurring form of crystalline carbon found in metamorphic and igneous rocks. In embodiments, the anode active material may include 100% wt. AG graphite, 100% wt. NG graphite, or a blend of AG graphite and NG graphite at any ratio (e.g., 75% wt. AG graphite/ 25% wt. NG graphite, 50% wt. AG graphite/50% wt. NG graphite, 25% wt. AG graphite/75% wt. NG graphite, and so forth).

The anode active material may include a binder of one or more of styrene-butadiene rubber (SBR), sodium carboxymethyl cellulose (CMC), polyacrylic acid (PAA), and/or carboxymethyl cellulose (CM). It will be appreciated that the binder in the anode active material may include other suitable binders.

The anode active material may include at least one carbon additive. For example, the carbon additives may include one or more of carbon black, graphite, graphene, graphene oxide, graphene nanoplates, Super P, acetylene black, carbon nanofibers, carbon nanotubes, single-walled carbon nanotubes (SWCNT), multi-walled carbon nanotubes (MWCNT) and other electronically conductive additives.

In embodiments, the anode 26 may include between about 90-99% wt. anode active material, between about 1-6% wt. binder, and between about 0-3% wt. In this context, the term “about” will be understood by one of skill in the art. Alternatively, the term “about” will be understood to mean plus or minus 0.2% wt.

In a specific example, the anode 26 and anode active material are formed with 97.44% wt. of an AG graphite/NG graphite blend mass ratio of 1:1 (e.g., 50% wt. AG graphite/50% wt. NG graphite), where the AG graphite has a median particle size (D50) of 12.5 μm with a specific surface are (BET) of 1.26 m²/g and the NG graphite has a median particle size (D50) of 11 μm with a specific surface are (BET) of 1.5 m²/g. In this example, the anode active material also includes a binder with 1.64% wt. CMC and 0.92% wt. SBR. When the cathode active material blend includes 100% wt. LMFP, the anode 26 has a capacity loading of about 3.63 mAh/cm² and a pressing density of 1.5 g/cm³. When the cathode active material blend includes 70% wt. LMFP and 30% wt. NCMA, the anode 26 has a capacity loading of about 3.85 mAh/cm² and a pressing density of 1.5 g/cm³. When the cathode active material blend includes 70% wt. LMFP and 30% wt. NCMA, the anode 26 has a capacity loading of about 3.8 mAh/cm² and a pressing density of 1.5 g/cm³.

The separator 30 includes a porous material formed of an electrically insulative material that prevents the cathode 24 and the anode 26 from contacting and potentially shortening out the battery circuit. The separator 30 is sandwiched, or at least partially enclosed, between the cathode 24 and anode 26 allowing the passage of the lithium ions and electrolyte 28 through the pores of the separator 30. The separator 30 may include one or more of a composite material, a polymeric material, or a non-woven material. In embodiments, the separator 30 includes at least one of polyethylene, polypropylene, polyamide, polytetrafluoroethylene, polyvinylidene fluoride, and polyvinyl chloride. In addition, the separator 30 may be filled, i.e., include fillers dispersed therein, wherein the filler includes a material, for example glass fiber. In additional or alternative embodiments, the separator 30 may include at least one of a thermally stable, porous polymer coating and a ceramic coating, for example an alumina coating. The coating may be disposed on one or more surfaces of a porous polymer film, where the polymer film may be selected from at least one of polyethylene and polypropylene. The separator 30 may include one or more layers, wherein each layer is formed from one or more of the materials noted above. The separator 30 may take the form of film or a mesh, such as woven mesh or a slit film. In embodiments, and when the separator 30 includes a coating and/or multiple layers, the separator 30 may be single or double-sided with a same or different coating layers, for example a polymer/separator/polymer layer, a polymer+ceramic/separator/polymer+ceramic layer, a polymer layer/ceramic layer/separator/ceramic layer/polymer layer, a polymer/separator/ceramic layer/polymer layer. Some examples of a single-sided separator 30 may include a polymer layer disposed on the separator 30, a polymer+ceramic layer on the separator 30, and/or a polymer layer disposed on a ceramic layer disposed on the separator 30. It will be understood that the separator may include other various configurations of layers and/or coatings.

In embodiments, the separator 30 exhibits a thickness of about 20 micrometers (μm) plus or minus 15 μm, including all values and ranges therein. In embodiments, a thickness of the coating (e.g., of a polymer coating) may be between about 1 μm and 10 μm. In this context, the term “about” will be understood by those of skill in the art. Alternatively, the term “about” means 0.5 μm. In one specific example, the separator 30 has a thickness of 12 μm, a porosity of 47%, and multiple coating layers of 2 μm Boehmite and 10 μm polyethylene.

The electrolyte 28 provides a medium between the cathode 24 and anode 26 through which lithium ions and the electrolyte 28 travel. The medium may be a liquid, gel, or solid, and capable of conducting the lithium ions between the cathode 24 and the anode 26. The electrolyte 28 permeates the pores of the porous separator 30 and wets, or otherwise contacts, the surfaces of the cathode 24 and anode 26 as well as the separator 30.

In embodiments, the electrolyte 28 includes one or more lithium salts dissolved in non-aqueous organic solvent. The lithium salts may include one or more of the following: lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiBOB) (LiB(C₂O₄)₂), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl) imide (LiN(F_{S}O₂)₂) (LiSFI), lithium (triethylene glycol dimethy 1 ether)bis(trifluoromethanesulfonyl)imide (Li(G₃)(TFSI), and/or lithium bis(trifluoromethanesulfonyl)azanide (LiTFSA). The lithium salt may be present in the electrolyte 28 at a concentration (moles of salt per liter of solvent (M)) ranging from 0.5M to 2.16M, including all values and ranges therein, for example 1M or 2M. The electrolyte may include a solvent (e.g., carbonate ester) and may include one or more additives (e.g., fluoroethylene carbonate (FEC), vinylene carbonate (VC), 1,3,2-dioxathiolane 2,2-dioxide (DTD), tris(trimethylsilyl) phosphite (TMSPi), lithium difluoro(oxalate)borate (LiDFOB), tris(trimethylsilyl) borate (TMSPB), and the like).

The electrolyte 28 may additionally include one or more of various alkyl carbonates, such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1,2-diethoxyethane, ethoxymethoxy ethane), and/or cyclic ethers (e.g., tetrahydrofuran, 2-methyltetrahydrofuran) , 1,3-dioxolane).

Further, the electrolyte 28 may include a number of additives, such as, but not limited to vinyl-ethylene carbonate (VEC), propane sulfonate, lithium difluorophosphate (LiPF₂O₂), and/or combinations thereof. Other additives may include diluents which do not coordinate with lithium ions but can reduce viscosity of the electrolyte 28, for example bis(2,2,2-trifluoroethyl) ether (BTFE), and/or flame retardants, for example triethyl phosphate.

In a specific example, the electrolyte 28 includes 1.2M LiPF₆, a solvent including 30% volume ethylene carbonate (EC) and 70% volume ethyl methyl carbonate (EMC), and additives including 2% wt. fluoroethylene carbonate (FEC) and 1% wt. vinylene carbonate (VC). It will be understood that the electrolyte 28 may include other suitable components and/or combinations of components.

The battery pack 12 and the battery cells 20 described herein may include an N/P ratio (e.g., a capacity ratio between the negative (anode) and the positive (cathode) electrodes) in the range of 1-1.2 and a voltage range between 2-4.5 volts (V). In a specific example, a battery cell 20 may include a 250×220×28.8 millimeter (mm) housing 18, with a volumetric energy density (VED) between 460-580 watt-hours per liter (Wh/L), a gravimetric energy density (GED) between 210-260 watt-hours per kilogram (Wh/kg), and a GED/VED at 30% of the State of Charge (SOC).

The lithium manganese iron phosphate (LMFP) based vehicle battery cell 20 and battery pack 12 of the present disclosure is advantageous and beneficial over the prior art. The optimized architecture and LMFP cathode active materials disclosed herein deliver a high thermal stability and a low cost product. Compared to conventional LMFP cathode materials, the optimized LMFP cathode active materials exhibit higher energy densities of 460-580 watt hours per liter (Wh/L) representing an improvement between 10-38%.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A lithium manganese iron phosphate (LMFP)-based vehicle battery cell, comprising:
a cathode current collector;
a cathode disposed on a surface of the cathode current collector, the cathode having an active material including at least one of
lithium manganese iron phosphate (LMFP) having a formula LiMnₓFe_{1-x-y}M_{y}PO₄, wherein M includes at least one of titanium (Ti), Magnesium (Mg), aluminum (Al), calcium (Ca), niobium (Nb), cobalt (Co), or yttrium (Y), wherein x=0.5-0.9, and wherein y=0-0.3; or lithium nickel cobalt manganese aluminum oxide (NCMA) having a formula LiNiCoMnAlO₂;
an anode current collector; and
an anode disposed on a surface of the anode current collector, the anode having an active material including graphite,
wherein the anode current collector and the anode are disposed proximate to the cathode current collector and the cathode, and wherein the anode and the cathode are separated by a separator.

2. The lithium manganese iron phosphate (LMFP)-based vehicle battery cell of claim 1, wherein the vehicle battery cell has an energy density between 460-580 watt-hours per liter (Wh/L).

3. The lithium manganese iron phosphate (LMFP)-based vehicle battery cell of claim 1, wherein the vehicle battery cell is at least one of a prismatic cell or a pouch cell.

4. The lithium manganese iron phosphate (LMFP)-based vehicle battery cell of claim 1, wherein the cathode current collector is aluminum.

5. The lithium manganese iron phosphate (LMFP)-based vehicle battery cell of claim 1, wherein the active material of the cathode includes a blend of LMFP and NCMA, and wherein the LMFP is greater than 50% of the blend.

6. The lithium manganese iron phosphate (LMFP)-based vehicle battery cell of claim 1, wherein the active material of the cathode has a formula of LiMn_{0.75}Fe_{0.25}PO₄.

7. The lithium manganese iron phosphate (LMFP)-based vehicle battery cell of claim 1, wherein a capacity loading of the cathode is about 3.3 milliampere-hours per square centimeter (mAh/cm²).

8. The lithium manganese iron phosphate (LMFP)-based vehicle battery cell of claim 1, wherein a porosity of the cathode is 35% plus or minus 8%.

9. The lithium manganese iron phosphate (LMFP)-based vehicle battery cell of claim 1, wherein the anode is formed of at least one of artificial graphite (AG) or natural graphite (NG).

10. The lithium manganese iron phosphate (LMFP)-based vehicle battery cell of claim 1, wherein the anode is formed of a blend of about 50% artificial graphite (AG) and about 50% natural graphite (NG).

11. The lithium manganese iron phosphate (LMFP)-based vehicle battery cell of claim 1, wherein the anode current collector is formed of copper.

12. The lithium manganese iron phosphate (LMFP)-based vehicle battery cell of claim 1, further comprising:
a binder.

13. The lithium manganese iron phosphate (LMFP)-based vehicle battery cell of claim 1, further comprising:
a carbon additive.

14. A battery for an electric vehicle, comprising:
a battery cell, the battery cell including:
a cathode current collector;
a plurality of cathodes, wherein each cathode includes an active material disposed on a surface of the cathode current collector, the active material including at least one of
lithium manganese iron phosphate (LMFP) having a formula LiMnₓFe_{1-x-y}M_{y}PO₄, wherein M includes at least one of titanium (Ti), Magnesium (Mg), aluminum (Al), calcium (Ca), niobium (Nb), cobalt (Co), or yttrium (Y), wherein x=0.5-0.9, and wherein y=0-0.3, or lithium nickel cobalt manganese aluminum oxide (NCMA) having a formula LiNiCoMnAlO₂;
an anode current collector;
an anode disposed on a surface of the anode current collector, the anode having an active material including graphite;
a separator positioned between the cathode and the anode; and
an electrolyte configured for carrying ions between the cathode and the anode.

15. The battery for the electric vehicle of claim 14, wherein the battery cell has an energy density between 460-580 watt-hours per liter (Wh/L).

16. The battery for the electric vehicle of claim 14, wherein the active material of the cathode has a formula of LiMn_{0.75}Fe_{0.25}PO₄.

17. The battery for the electric vehicle of claim 14, wherein the active material of the cathode includes a blend of LMFP and NCMA, and wherein the LMFP is greater than 50% of the blend.

18. The battery for the electric vehicle of claim 14, wherein the anode is formed of at least one of artificial graphite (AG) or natural graphite (NG).

19. The battery for the electric vehicle of claim 14, wherein the anode is formed of a blend of about 50% artificial graphite (AG) and about 50% natural graphite (NG).

20. A lithium manganese iron phosphate (LMFP)-based vehicle battery cell, comprising:
a cathode current collector;
a cathode disposed on a surface of the cathode current collector, the cathode having an active material including at least one of
lithium manganese iron phosphate (LMFP) having a formula LiMnₓFe_{1-x-y}M_{y}PO₄, wherein M includes at least one of titanium (Ti), Magnesium (Mg), aluminum (Al), calcium (Ca), niobium (Nb), cobalt (Co), or yttrium (Y), wherein x=0.5-0.9, and wherein y=0-0.3; or nickel, cobalt, manganese, and aluminum (NCMA) having a formula LiNiCoMnAlO₂;
a carbon additive; or
a binder;
an anode current collector; and
an anode disposed on a surface of the anode current collector, the anode having an active material including graphite and at least one of a carbon additive or a binder,
wherein the anode current collector and the anode are disposed proximate to the cathode current collector and the cathode, and wherein the anode and the cathode are separated by a separator.
